(19) United States
(12) Patent Application Publication
(10) Pub. No.: US 2011/0168677 A1
(43) Pub. Date: Jul. 14, 2011

(54) ELECTRIC WELDING OF ALUMINIUM OR ALUMINIUM ALLOY

(75) Inventor: Ketil Hornaes, Skien (NO)

(73) Assignee: EFD INDUCTION A.S., Skien (NO)

(21) Appl. No.: 12/809,087

(22) PCT Filed: Dec. 17, 2008
(86) PCT No.: PCT/NO08/00457

§ 371 Date: Mar. 23, 2011

(30) Foreign Application Priority Data
Dec. 21, 2007 (NO) 20076637

(51) Int. Cl. B23K 9/16; B23K 35/22; B05D 5/12; B05D 1/36; B05D 3/00; C25D 7/06

(52) U.S. Cl. 219/74; 219/145.1; 427/59; 205/138

(57) ABSTRACT

Electric welding method is provided of aluminium or aluminium alloy in a magnetic field, the aluminium or aluminium alloy adjacent to a weld joint under formation has an oxide layer, and the free end of a welding wire is supplied with a surrounding shielding gas. Furthermore, a welding wire is used that comprises aluminium or aluminium alloy provided with an oxide-inhibiting coating, which forms the outer covering or sheath of the welding wire and/or that as said shielding gas there is used a shielding gas with oxygen incorporated therein, or that the shielding gas is supplied with oxygen during the welding process. When the process is carried out in a magnetic field, the minimum frequency of the welding current is selected as a function of the strength of the magnetic field. A method is also provided for producing the welding wire and necessary material conditions for a usable welding gun.

### FIELD OF INVENTION

The present invention relates to aspects of electric welding of aluminium or aluminium alloy, and in particular where the welding is to be carried out in locations in which there is a powerful magnetic field, as, e.g., in aluminium electrolysis halls.

More specifically, the invention relates to a method of electric welding as disclosed in the preamble of attached claim 1, a welding electrode for use in the electric welding process and as disclosed in the preamble of attached claim 12, an apparatus for electric welding and as disclosed in the preamble of respective attached claim 15, a method for producing welding wire and as disclosed in the preamble of attached claim 28, a use of the welding wire as disclosed in claim 33, a feedable and consumable welding wire as disclosed in claim 36, a device for producing welding wire and as disclosed in the preamble of attached claim 37, and a welding gun for use in the welding process and as disclosed in the preamble of attached claim 41.

In this text, the term “welding wire” is to be understood as synonymous with the term “welding electrode”.

### BACKGROUND

To illustrate the prior art, mention can be made of U.S. Pat. No. 3,894,210, US 2004/0173593 Al, U.S. Pat. No. 6,303,892, Patent Abstracts of Japan & JP 04365881, GB 285674 and GB 731836.

U.S. Pat. No. 3,894,210 describes a solution in which aluminium is not added to the weld pool, as only a non-consumable tungsten electrode is used. The document describes an electric circuit for square-wave alternating current for TIG welding of aluminium. Alternating current is necessary in this case for oxide cleaning. A square form instead of a sine form facilitates re-ignition during zero crossing. Moreover, the current magnitude may be pulsed (for molten pool control) and increased/reduced at start-up/stop. This is standard commercial TIG procedure today. It cannot be used with MIG (GMAW) welding.

US 2004/0173593 Al describes the use of shielding gases in GMAW welding of aluminium to prevent burn-through, to bridge over large root gaps and to increase welding rate. The use of alternating current contributes to this by reduced penetration and more deposit per ampere of current intensity. Small amounts of reactive gases and also helium are added to argon shielding gas. As for the alternating current, the frequencies that seem to be involved in this case are in the range 0.4-0.25 Hz.

U.S. Pat. No. 6,303,892 relates only to alternating current TIG welding of aluminium with an extra large amount of helium (83-95%) in the shielding gas. To stabilise this addition, small amounts of different multiatom reactive gases are added with the remainder of the argon. It is well known that alternating current reduces the penetration depth, whilst an addition of helium increases it. Helium is thus intended to compensate for alternating current.

Patent Abstracts of Japan & JP 04365881 describes electric resistance point welding and is not relevant to arc welding. Point welding of aluminium is more difficult than point welding of steel because the basic material easily sticks to the pressure electrodes of copper alloy. To prevent this, the sheets (i.e., the workpieces) are given an extra thick oxide layer by anodisation. This oxide layer is then coated with a thin metal layer which gives good electrical contact.

GB 285674 relates to technology from the infancy of arc welding, which relates to covered electrodes (shielded metal arc welding, SMAW). GMAW had not been invented at that time. The document provides a formula for a flux shield suitable for welding and soldering aluminium. The shield is intended to prevent the formation of aluminium oxide on molten droplets and molten pools. Shielding gas is of course not used in this method. It is stated that the aluminium rod may be coated electrolytically with copper or nickel before the flux shield is arranged on the outside. The object optionally is in addition to reduce the amount of oxide in the melt. The copper is applied with the object of being a binder for the flux. The flux seems to have the purpose of protecting the molten pool from reacting with air, i.e., the same function that the addition of shielding gas has in GMAW welding.

GB 731836 describes various additives added either to the electrode, the shielding gas or on the workpiece in order to be able to carry out GMAW welding using alternating current. The object of the additives is to lower the ionisation potential in the molten metal so as to facilitate re-ignition of the arc during zero crossing. Of eight test examples, seven relate to steel and one to aluminium.

For the record, it may be mentioned that it is generally known that steel can be welded in magnetic fields in the frequency range 8-16 kHz. However, here asymmetry of the welding arc is not a problem because the electrode is hot and so has a high electron emissivity, which gives symmetrical current. The problems associated with the welding of aluminium and aluminium alloys in a powerful magnetic field are therefore very different from what has been known earlier.

It is known that there are a number of practical problems involved in carrying out 5 electric welding of aluminium. In production plants for aluminium works, the power rails used are as a rule made of aluminium, and to join such power rails there are two possibilities: either the use offish plates with nut and bolt fastening, or the use offish plates welded on in layers to form an electrical bridge connection over the location of the joint. In general, it is preferable to avoid the first-mentioned alternative and to try to weld weld the joint instead.

Welding of aluminium rails in a magnetic field, often a very strong magnetic field, for example, 100 Gauss or stronger because of substantial direct currents flowing in the rails, generally make welding impossible, which is due to the thus absent ignition of the is arc. In weaker magnetic fields, asymmetric welding will be produced and thus poorer weld quality. Welding of aluminium in magnetic fields is therefore generally problematic. One task is thus to obtain symmetry in the welding arc in powerful magnetic fields, so as to minimise the need for stoppages in the aluminium production for service and maintenance, and at the same time reduce the power consumption of the Q smelting works.

Moreover, in general during the welding of aluminium it has however been found difficult to obtain a satisfactory weld because the arc has had a tendency to move to an area adjacent to the weld joint under formation. This is due in general to the fact that 5 the arc has a tendency to move from the welding wire towards the oxide coating that will always be present at the welding point, i.e., on the areas adjacent to the weld joint location.

It is commonly known that aluminium is a reactive, electronegative metal which, 0 because of the presence of oxygen in the air, is naturally protected by an oxide coating consisting OfAl₂O₃. This thin and dense ceramic coating, also termed alumina, is self-repairing and prevents further oxidation of the aluminium or corrosion. It is also known that aluminium oxides generally have a lower electronic ionisation potential than pure aluminium surfaces. This means that electric arcs will prefer to ignite towards these 5 areas, even though there are pure aluminium surfaces with shorter flash-over distances. This is caused by the phenomenon known as electric ionisation potential, for which another English term is “work function”.

An obvious solution would thus be to try, in connection with welding, to pre-polish the edge area of the joint so as to remove as much of the alumina layer as possible. However, such a solution proved to be awkward and hazardous because of the powerful magnetic field that could affect machining tools, but not least it was impractical because oxide layers are in any case formed almost immediately on aluminium or aluminium alloy.

There was therefore a need to perfect the arc from the welding wire to the workpiece, so that, if possible, it could move maximally between the end of the welding wire and the actual weld pool.

However, this was not the only challenge that was seen in connection with the welding of aluminium or aluminium alloy, because when, for example, welding aluminium or aluminium alloy in an aluminium production plant (electrolysis hall), it is essential that as little of the plant as possible is shut down whilst welding takes place.

In such electrolysis halls there is a particular need at intervals to be able to join current-carrying rails of aluminium or aluminium alloy. Although no current is carried in the rail that is to be joined whilst the welding takes place, adjacent power rails will nevertheless often at the same time be current-carrying with current intensities in the order of 10,000 amperes or more, which causes a powerful and complicating magnetic field area where the welding is to be done, which in turn has an adverse effect on the behaviour of the arc. In addition, the welding equipment is also in this magnetic field area.

### SUMMARY

According to one inventive feature of the invention, the adverse effect which is caused by said magnetic field area was countered by the welding wire not being fed in the conventional manner with direct current, but with intermediate frequency or high frequency alternating current instead. This largely solved the problem related to the “blowing” effect the magnetic field had on the welding arc. As shielding gas, argon was used in the tests, although other shielding gases could have been used. Such alternating current should have such a high frequency that the minimum frequency is set as a function of the prevailing magnetic field. A symmetrical alternating current in the arc will reduce the effect of a magnetic field thereon, as the forces on the arc will be displaced 180° in each half-period. Increased alternating current frequency will reduce the effect from the magnetic field. It will be understood that there is an optional direct current component in the alternating current that is affected by the magnetic field. Also an irregular geometric or spatial distribution of current on the electrode will give a direct current component on the molten end of the electrode, which will cause molten droplets from the electrode, i.e., the consumable welding wire, to be flung to the side. 5 Expediently, the alternating current used is a sine current or a current having an approximate sine form, although this is not an absolute requirement.

However, it was seen that this does not provide a complete solution to the problems involved in obtaining a satisfactory welding process, and by means of the additional inventive feature of allowing the shielding gas in addition to contain a small portion of oxygen, the welding results were considerably improved, in the sense that it was largely possible to prevent the arc from re-igniting at the side of the actual weld pool. This solution involves the actual molten pool in the joint that is to be formed being supplied with a small amount of oxygen, which caused the arc to have better conditions for re-5 igniting towards the now more oxygen-containing molten pool instead of towards the edge portions of the weld pool where there is an oxide coating. As the occurring arc, which as a rule seeks the shortest path, will however prefer oxidised aluminium instead of pure aluminium in the weld pool upon re-ignition, such supply of a little oxygen to the weld pool will thus cause the arc to go the shortest way from the welding electrode (the welding wire) to the weld pool, the weld pool when thus supplied with oxygen acquiring a slightly oxidised surface. The addition of oxygen is therefore important for improving the arc conditions at the welding point.

It was discovered however that at the same time there were some other phenomena 5 which prevented optimal welding results. On a closer high-speed camera-assisted study, it was seen that it is not only the aluminium or aluminium alloy that is to be joined which causes problems, but also the welding wire, as the studies carried out revealed that there was an arc phenomenon between an area on the welding wire upstream of its free end and the area adjacent to the weld joint under formation during0 one of the half-periods of alternating current. The free end of the welding wire then carries an asymmetric current, which in turn results in an asymmetric impact on the magnetic field.

This discovery therefore also identified a need to find a solution that would make its possible to obtain an even more stable electric arc between the end of the welding wire and the weld joint under formation in both half-periods of the alternating current.

In order further to perfect the welding process, the welding wire, i.e., a feedable and consumable welding wire of aluminium or aluminium alloy, according to yet another additional feature of the invention, was provided with an outer covering or sheath of oxide-inhibiting coating of, for example, copper, as it was acknowledged that in one of the half-periods of the current, the electric arc without such coating would unfortunately pull towards the oxide coating that is located upstream of the end of the welding wire, i.e., not towards the melted end of the welding wire. This measure resulted in a considerable improvement of the welding process. By thus countering oxide coating on the aluminium wire, it is ensured that the electric arc will always burn from the end of the welding wire/electrode.

According to the invention, the aforementioned method for use in electric welding is characterised by the features set forth in attached claim 1, and additional embodiments can be seen from subsidiary claims 2-11.

To obtain an optimal result of the welding process, the aforementioned welding electrode is characterised by the features set forth in attached claim 12, i.e., that the welding electrode in the form of a feedable and consumable welding wire of aluminium or aluminium alloy has an outer covering or sheath of oxide coating, in the non-limiting example, a thin layer of copper. Traditionally, it takes some time before an oxide coating is formed on copper. Other embodiments of the welding wire are set forth in subsidiary claims 13 and 14.

Like what is stated above in connection with the method, the aforementioned apparatus is characterised by the features set forth in attached claim 15. Additional embodiments of the apparatus as defined in claim 15 are set forth in subsidiary claims 16-27.

A welding wire of aluminium or aluminium alloy provided with an oxide-inhibiting coating is not previously known, and as a natural aspect of the invention, there is therefore provided a method of producing a welding wire of aluminium or aluminium alloy with an oxide-inhibiting coating, as can be seen from the characterising clause of claim 28. Additional embodiments of the method are set forth in attached subsidiary claims 29-32. The use of a welding wire, which is produced according to this method, is also disclosed in attached claim 33, and its associated subsidiary claims 34 and 35.

In addition, claim 36 discloses features related to a feedable and consumable welding wire.

For carrying out the method of producing a welding wire of aluminium or aluminium alloy with an oxide-inhibiting coating, the invention indicates a device as defined in attached claim 37. Additional embodiments of the device are disclosed in attached 5 subsidiary claims 38-40.

When welding aluminium or aluminium alloy, traditionally a welding gun is used for gas-metal arc welding, so-called GMAW. When the welding gun, instead of a supply of direct current, is adapted to be fed with welding current in the form of alternating i o current selected in the frequency range of 500 Hz-100 kHz, it is indicated, according to a further aspect of the invention, that all parts within and on the welding gun consist of non-magnetic material, as disclosed in claim 41. This is also of significance when the welding gun is to operate in a magnetic field, such as when welding power rails in an electrolysis hall where powerful magnetic fields are present. It is in this case important is to prevent use of the welding gun from being hazardous in that it may uncontrollably wander because it has mounted thereon or contains ferromagnetic parts. Ferromagnetic parts will also be inductively heated by an alternating current based welding current. The degree of heating will be a function of frequency and current. Q Although the invention will be especially useful in connection with welding in a powerful magnetic field, it will be understood that the invention is also perfectly usable in connection with welding where the magnetic field is weak, or where the effect from the magnetic field is insignificant. Of course, welding could also be carried out where a magnetic field is not present

### BRIEF DESCRIPTION. OF THE DRAWINGS

The invention will now be explained in more detail with reference to the attached drawings, which illustrate non-limiting exemplary embodiments.

FIG. 1 shows a weld joint with adjacent portions of aluminium or aluminium alloy that are to be joined and related arc phenomena.

FIG. 2 illustrates purely schematically the welding conditions for power rails in a smelting plant. 5 FIG. 3 shows schematically, and with proportions not to scale, a cross-section of the welding wire according to the invention.

FIG. 4 is a sectional view of a typical welding gun.

FIG. 5 shows a welding apparatus according to the invention.

FIG. 6 shows the principle of incorporating oxygen into the shielding gas if the shielding gas does not have a defined oxygen content as it comes from the gas manufacturer.

FIG. 7 shows an alternative solution for supply of oxygen to the shielding gas during the welding process.

FIG. 8a shows in a perspective top view a device for producing the oxide-inhibiting coating on the welding wire, and FIG. 8b is a top view of the device.

### DETAILED DESCRIPTION OF THE PREFERRED EMBODIMENT(S)

As mentioned initially, it has, in connection with the method and apparatus for use in electric welding of aluminium or aluminium alloy, been established that such metal adjacent to a weld joint under formation has an oxide layer. During the welding process, a free end 1′ of the welding wire 1 must be supplied with a surrounding shielding gas via suitable wire guide 2 in a welding gun 3.

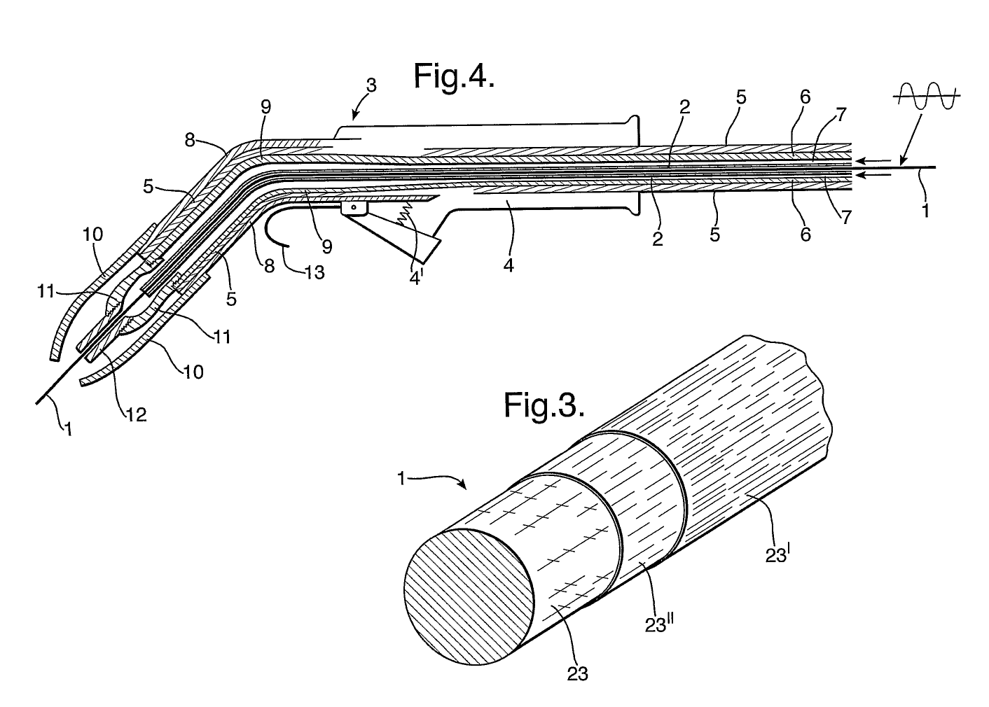

The welding gun 3 as shown in FIG. 4 is an ordinary GMAW welding gun comprising a gun handle 4, insulation 5, a flexible copper conductor 6 for current feed, space 7 for transporting shielding gas, the wire guide 2 for the welding wire 1, an outer copper tube 8 extending from the handle, an inner copper tube 9 for current feed, gas mouthpiece 10, gas nozzle 11, and contact tube 12 for feeding current to the welding wire. Furthermore, the welding gun is equipped with a hanging hook 13.

For the challenges that the invention is to solve in general, but particularly in a welding environment where there is a magnetic field (often a powerful magnetic field), it has, in connection with the invention, been found expedient to use alternating current as welding current, and that in addition a shielding gas is used which has oxygen incorporated therein, or that the shielding gas is supplied with oxygen during the welding process.

The most natural and easiest approach would be that the shielding gas has oxygen incorporated therein in the correct proportions by the supplier of the gas. However, ready mixed shielding gas containing oxygen may not always be available, and in this connection, a mixing valve 14 is advantageously used as shown in FIG. 6, which is supplied from a first gas reservoir 15 and a second gas reservoir 16. The first gas reservoir 15 contains, for example, argon and the second reservoir 16 contains, for example, argon with a percentage of oxygen or only oxygen. If, for example, 1% O₂ is required in the shielding gas 17 exiting the mixing valve 14, the second reservoir 16 may, for example, contain argon with 2% added O₂. If the mixing valve 14 is reliably adjustable and thus finely adjustable, the second gas reservoir may, for example, contain O₂. The mixing valve may optionally be of the injector type, for example, based on the Bernouilli tube principle.

In an alternative approach, O₂ can be added directly at the welding point 18, as for example indicated in FIG. 7, via a separate jet nozzle 19.

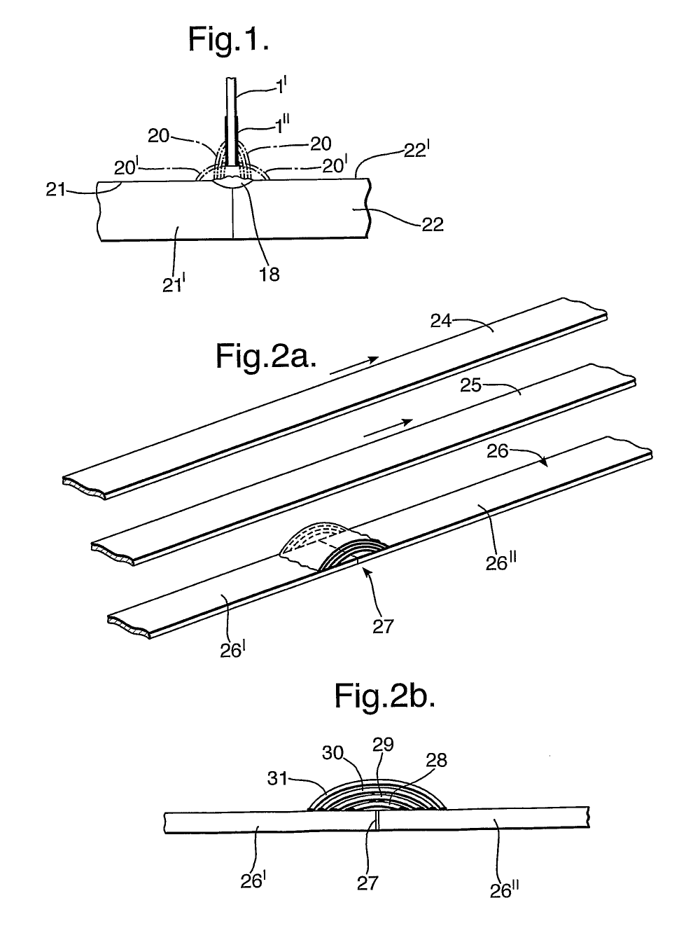

As previously indicated, when an alternating current is used as welding current, as indicated in FIG. 4, there will be problems in one of the half-periods of the alternating current in that the natural oxide coating 1″ of the welding wire 1 attracts the arc 20, which is unfortunate for the welding wire and the welding process as a whole, hi the other half-period, the arc 20′ will pull towards the edge portion of the weld pool where, for example, a power rail 21, 22 has an oxide coating 21′, 22′. This is indicated in more detail in FIG. 1. To remedy this, a welding wire 1 is used which essentially consists of a core 23 of aluminium or aluminium alloy provided with oxide-inhibiting coating 23′ which forms the outer covering or sheath of the welding wire. A binding layer 23″ is advantageously located between the coating 23′ and the core 23. This is shown in more detail, on a highly enlarged scale in FIG. 3.

For further optimisation, in addition to the use of alternating current and the specially designed welding wire, there may also be used as said shielding gas a shielding gas in which oxygen is incorporated, or that the shielding gas is supplied with oxygen during the welding process, as described above.

In the case that oxygen is incorporated into or added to the shielding gas, the volume amount will advantageously be selected in the range of 0.1-5%. It is not particularly desirable that the oxygen content should be too great, and preliminary tests have shown a volume amount of oxygen in the range of 0.75%-2.5% may be sufficient.

The point of allowing the shielding gas to contain oxygen, either incorporated therein in advance or added during the welding process, is, as mentioned above, to cause the weld pool 18 in the weld joint to be supplied with oxygen, so that the arc from the welding wire 1 will seek to move to where it is actually supposed to be, namely towards the weld pool 18 which, on solidifying, will form the weld joint. Without the oxygen that comes into the shielding gas, the weld pool will behave more like pure aluminium or aluminium alloy, and the arc will thus have a tendency to wander away from the desired weld pool.

Preliminary tests have, however, shown that the requirement of an oxygen content in or an oxygen supply to the shielding gas is not always as rigid, and that in some cases the use of alternating current having correctly adjusted frequency, specially designed welding wire with oxide-inhibiting coating and ordinary shielding gas, i.e., with no oxygen, will be sufficient or at least acceptable.

The shielding gas will contain at least one inert gas in addition to the optional presence of oxygen.

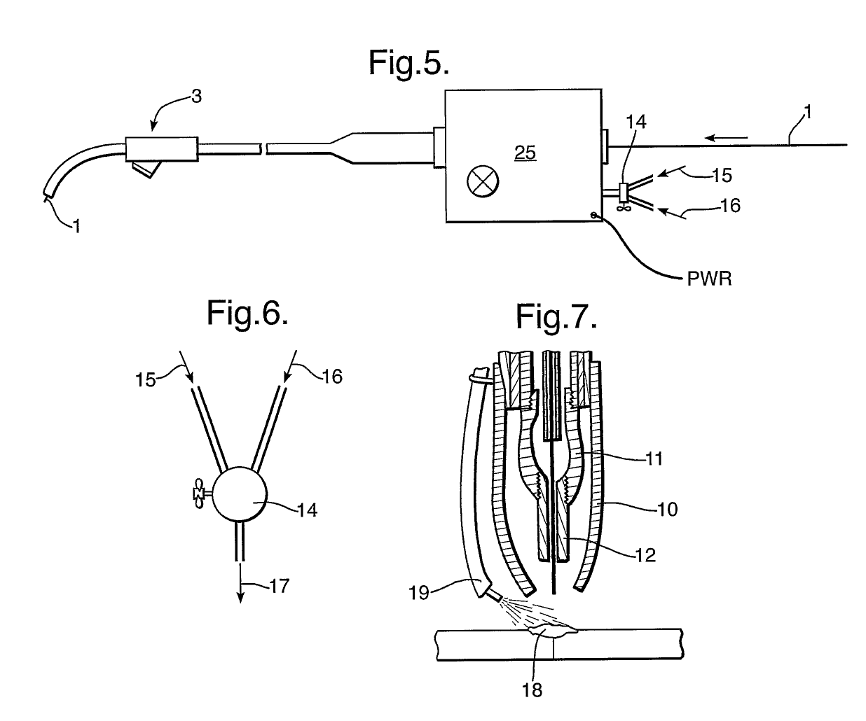

The alternating current used is expediently selected in the range of 500 Hz-500 kHz. When the welding process is carried out in a magnetic field, as for example when welding power rails 24-26 in an aluminium electrolysis hall, the minimum frequency of the welding current must be chosen as a function of the strength of the magnetic field. The greater the magnetic field, the higher the said frequency must be. This means that the frequency of the welding current delivered from the welding current generator 25 when the welding operation takes place in a magnetic field, must always at least be on a certain adapted minimum frequency to counteract the effects of the magnetic field. Welding frequency is a result of the resonance frequency of the welding current circuit, and it is adjusted automatically by means of a regulator 26, as shown in FIG. 5.

When a junction 27 is to be welded in this way, it is often expedient to carry out the weld using fish plates 28-31 which are welded successively and in layers on the adjacent rail parts 26′, 26″. If the junction 27 is V-shaped, it is of course possible to carry out the welding in layers until the junction is filled with welded-on aluminium or aluminium alloy.

As mentioned, it has been found, in connection with the invention, to be advantageous to use a welding wire that essentially consists of aluminium or aluminium alloy and is also provided with an outer covering or sheath of an oxide-inhibiting coating. This prevents the adverse effects ordinarily caused by aluminium oxide (alumina) coating on the welding wire, i.e., that the arc in a phase of the alternating current tends towards an area located upstream of the tip of the welding wire. As oxide-inhibiting coating, copper (Cu), gold (Au), silver (Ag) or platinum (Pt) may, for example be used, although other metal coatings are conceivable.

In the preliminary tests that have been carried out, it has been found that copper is an inexpensive, suitable and readily applicable metal. One of the properties of copper, like a number of other metals, is that it oxidises very slowly, in strong contrast to aluminium which oxidises almost the instant it comes in contact with air to form a very hard oxide coating.

As indicated in FIG. 3, on a somewhat incorrect scale, the oxide-inhibiting coating 23′ is thin compared with the cross-sectional radius of the welding wire 1, for example, so that the coating has a thickness that constitutes 0.025%-2.5% of the cross-sectional radius of the welding wire 1. This means that the actual core 23 of the welding wire 1, which is of aluminium or aluminium alloy, constitutes the major part of the material volume of the welding wire. As indicated in FIG. 3, between the coating of the aluminium or aluminium alloy in the welding wire said binding layer 23″ may be found, for example, formed of zinc (Zn). The oxide-inhibiting layer 23′ should be as thin as possible, but at the same time have such a thickness and strength that it is not easily stripped off or flakes off the welding wire 1.

Although it is possible to allow the welding wire to have the form of a welding wire of a shorter length, it is preferred that a long welding wire, continuously feedable from the welding gun during welding, is used as is standard practice in GMAW type welding.

Today, welding wire with such oxide-inhibiting coating is not a commercial product. This is because the use of alternating current for the welding of aluminium or aluminium alloy, and especially when welding takes place where there are powerful magnetic fields, but also where there are weaker magnetic fields, has not previously been employed. Welding of aluminium and aluminium alloy in this way has, as mentioned above, presented serious problems that had to be solved. It is true that there are electric cables, especially for audio equipment, as for instance loudspeakers, where the cables have a core of aluminium that is coated with copper and then has an electrically insulating sheath applied, but such cables are of course not intended for welding of the GMAW type.

At the inception of the invention and the emergence of challenges that gradually had to be solved and were solved, it was seen immediately that there was a need to provide a method and a device for producing welding wire for use in electric welding of aluminium or aluminium alloy.

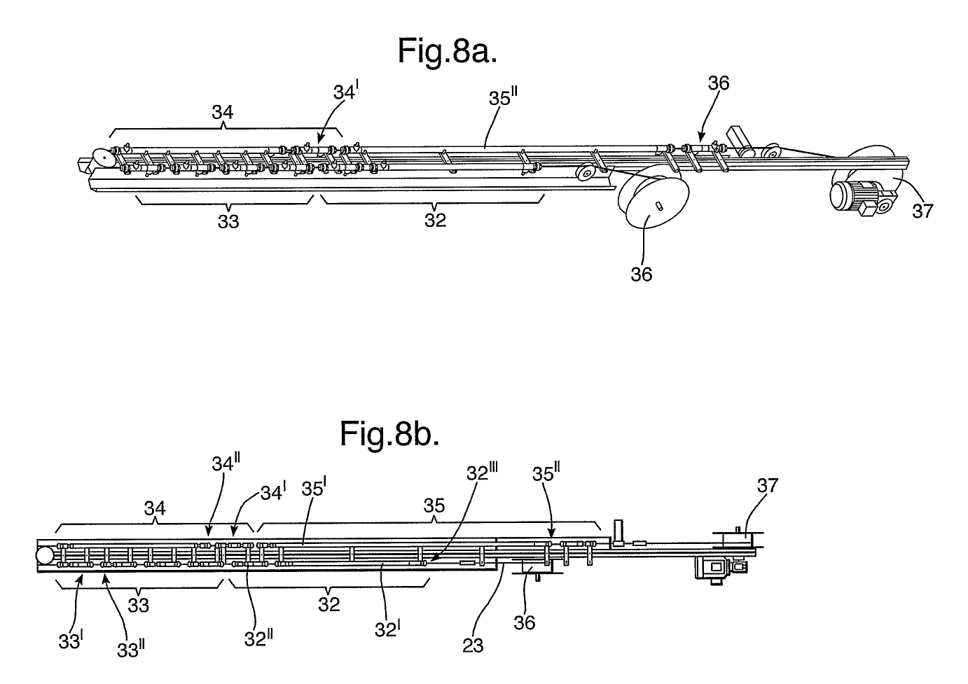

FIGS. 8a and 8b show a device for producing welding wire for use in electric welding of aluminium or aluminium alloy. Although the device shown in the figures may later be modified with a view to more commercial treatment of the welding wire 1; 23-23″, the figures show a currently realisable device for facilitating such production.

FIGS. 8a and 8b show a plurality of workstations 32-35 which are adapted to treat the welding wire during its passage through the workstations from a first store 36 of untreated welding wire 23 of aluminium or aluminium alloy to a second store 37 of ready treated welding wire 1; 23, 23″, 23′.

This plurality of welding stations consists of, in sequential order: a first workstation 32 adapted to degrease 32′ and wash 32″ a wire 23 of aluminium or aluminium alloy which has a first thickness and which is supplied from the first store, a second workstation 33 adapted to remove oxide coating from the wire, a third workstation 34 adapted to apply a binding layer on the wire, and a fourth workstation 35 configured with a feedthrough chamber 35′ designed for electrolytic application of oxide-inhibiting metal coating 23′ on the binding layer 23″. The feedthrough chamber 35′ may comprise therein an anode (not shown) made of an oxide-inhibiting material, or the chamber itself may be made of such a metal.

It may be expedient to allow, for example, the storage coil 36 of untreated aluminium wire or aluminium alloy wire 23 to be put on a negative voltage potential, but it is of course also possible to allow the storage coil 37 of ready treated wire 1; 23, 23″, 23′ to be put on such potential. The stations 34, 35 that are to carry out electrolysis for application of binding layer 23″ and oxide-inhibiting layer 23′, respectively, are then put on a positive potential.

The exposure time of the wire 23, 23″ with applied binding layer in the fourth station 35 is so adapted that the oxide-inhibiting coating 23′, on passing out of the downstream end 35″ of the fourth workstation 35, has a thickness which is 0.025%-2.5% of the cross-sectional radius of the welding wire upstream in relation to the upstream end 32′″ of the first workstation.

The binding layer can be applied in the third workstation 34 either by electrolysis (electroplating), by spray application of atomised binder or in that the layer adheres to the degreased welding wire on being passed through a bath of melted binder. However, electrolysis is the currently preferred method. Expediently, the binding layer may consist of zinc (Zn), and the metal of the oxide-inhibiting coating is made in a currently preferred embodiment of copper (Cu).

It may be an advantage to allow the second workstation 33 and the third workstation 34 in addition to have a respective washing section and optional rinsing section 33′; 34′ at their respective downstream end 33″; 34″. This may be an advantage in the sense that the different treatment baths in the stations have a longer lifetime, but if more frequent changes of treatment liquids are accepted, such additional washing sections can be omitted. The reference numerals 38 and 39 designate collecting channels for collecting any liquid leakages that may occur from the treatment stations.

As previously indicated, a welding wire which is made in this way will, via the treatment steps it undergoes, be especially suitable in connection with the use of welding current in the form of alternating current with a frequency in the range of 500 Hz-100 kHz and in connection with the use of shielding gas, either with or without the addition of an oxygen portion. As described, such welding wire is especially suitable for welding aluminium or aluminium alloy in a magnetic field.

As mentioned, welding using alternating current poses problems as regards the ferromagnetic parts that are within or on the outside of the welding gun of the GMAW type. At the high welding frequencies that can occur, these parts may have an adverse influence on the function of the welding gun and an operator's possibility of operating the gun in a reliable manner. A standard welding gun of this type contains internal springs 4′, screws and joints of a ferromagnetic type, and in addition the gun is often equipped with hose clips, connector pieces and a hanging hook 13 of ferromagnetic material.

When, therefore, the welding gun is adapted to be supplied with welding current in the form of alternating current selected in the said frequency range, it is, according to the invention, important that all parts within and on the welding gun consist of nonmagnetic material. The importance of this is of course also present when welding is carried out in a magnetic field.

It will be understood that within the scope of the different aspects of the invention it is possible to configure, for example, the welding gun in a different way than that shown as a roughly outlined example. The direct spray nozzle for oxygen or oxygen-containing shielding gas which is shown in FIG. 7 would be fastenable to the outside of the welding gun with the aid of non-ferromagnetic fastening means.

1. A method for use in electric welding of aluminium or aluminium alloy, where the aluminium or aluminium alloy adjacent to a weld joint under formation has an oxide layer, and wherein the free end of a welding electrode is supplied with a surrounding shielding gas,
wherein
the welding is carried out in a magnetic field;
as welding current there is used an alternating current which has a minimum frequency that is a function of the strength of the magnetic field; and
as welding electrode there is used a feedable and consumable welding wire which essentially consists of aluminium or aluminium alloy, and which is provided with an oxide-inhibiting coating that forms the outer covering or sheath of the welding wire.

2. A method as disclosed in claim 1, wherein
as said shielding gas there is used a shielding gas with oxygen incorporated therein, or that the shielding gas, during the welding process, is supplied with oxygen.

3. A method as disclosed in claim 2, wherein
the volume amount of incorporated or added oxygen is in the range of 0.1-5%.

4. A method as disclosed in claim 3, wherein
the volume amount of incorporated or added oxygen is in the range of 0.75%-2.5%.

5. A method as disclosed in claim 2, wherein
the shielding gas contains, besides the aforementioned oxygen, at least one inert gas.

6. A method as disclosed in claim 1, wherein
as said oxide-inhibiting coating copper (Cu), gold (Au), silver (Ag) or platinum (Pt) is used.

7. A method as disclosed in claim 2, wherein
said oxygen is fed to the rest of the shielding gas via a mixer valve.

8. A method as disclosed in claim 1, wherein
there is used a coating which has a thickness that constitutes 0.025%-2.5% of the cross-sectional radius of the welding wire.

9. A method as disclosed in claim 1, wherein
the alternating current fed to the welding wire has a frequency selected in the range of 500 Hz-500 kHz.

10. A method as disclosed in claim 1, wherein
the alternating current used is a symmetric alternating current without a direct current component.

11. A method as disclosed in claim 1, wherein
the alternating current is supplied as a constant alternating current or an intermittent or pulsating alternating current.

12. A welding electrode for use in electric welding of aluminium or aluminium alloy, wherein the aluminium or aluminium alloy adjacent to a weld joint under formation has an oxide layer, and where the free end of the welding electrode during welding is supplied with a surrounding shielding gas, wherein
the welding electrode is designed for welding in a magnetic field and is formed of a feedable and consumable welding wire which consists essentially of aluminium or aluminium alloy and which has an outer covering or sheath of an oxide-inhibiting coating.

13. A welding electrode as disclosed in claim 12, wherein
the coating is of copper (Cu), gold (Au), silver (Ag) or platinum (Pt).

14. A welding electrode as disclosed in claim 12 wherein
the coating has a thickness which constitutes 0.025%-2.5% of the cross-sectional radius of the welding wire.

15. An apparatus for use in electric welding of aluminium or aluminium alloy which has an oxide layer adjacent to a weld joint under formation, comprising a welding electrode whose free end is suppliable with a surrounding shielding gas from a shielding gas source, wherein
the apparatus is designed for welding in a magnetic field;
the welding electrode is formed of a feedable and consumable welding wire that is adapted to be fed with an alternating current from a power supply of the apparatus, the alternating current having a minimum frequency that is a function of the strength of the magnetic field; and
the welding wire is of aluminium or aluminium alloy and is provided with an outer covering or sheath of an oxide-inhibiting coating.

16. An apparatus as disclosed in claim 15, wherein
the shielding gas contains oxygen or that means are present for feeding oxygen to the shielding gas during welding.

17. A device as disclosed in claim 16, wherein
said oxygen is added to the shielding gas that is in the shielding gas source.

18. An apparatus as disclosed in claim 16, wherein
a means is provided for adding oxygen to the shielding gas at the weld joint.

19. An apparatus as disclosed in claim 16, wherein
the oxygen-containing shielding gas is a mixture, fed from a mixing valve, of oxygen-free shielding gas from a first gas source and an oxygen-containing shielding gas or oxygen from a second gas source.

20. An apparatus as disclosed in claim 19, wherein
the mixing valve is configured as an injector.

21. An apparatus as disclosed in claim 15, wherein
the amount of incorporated or added oxygen in the shielding gas is in the range of 0.1-5%, preferably in the range of 0.75%-2.5%.

22. An apparatus as disclosed in claim 15, wherein
the shielding gas contains, besides said oxygen, at least one inert gas.

23. An apparatus as disclosed in claim 15, wherein
the oxide-inhibiting coating is a coating of copper (Cu), gold (Au), silver (Ag) or platinum (Pt).

24. An apparatus as disclosed in claim 15, wherein
the oxide-inhibiting coating has a thickness which constitutes 0.025%-2.5% of the cross-sectional radius of the welding wire.

25. An apparatus as disclosed in claim 15, wherein
the alternating current supplied has a frequency selected in the range of 500 Hz-500 kHz.

26. An apparatus as disclosed in claim 15, wherein
the alternating current employed is a symmetrical alternating current with no direct current component.

27. An apparatus as disclosed in claim 15, wherein
the alternating current is supplied as a constant alternating current or an intermittent or pulsating alternating current.

28. A method of producing a welding electrode for use in electric welding of aluminium or aluminium alloy, wherein
the welding electrode is formed of a feedable and consumable welding wire for use in welding in a magnetic field, and where the production takes place by:
a) providing a wire of aluminium or aluminium alloy which has a first thickness;
b) providing the wire with a first coating that forms a binding layer; and
c) providing the first coating with a second coating that is oxide-inhibiting and adapted to form the outer covering of the welding electrode.

29. A method as disclosed in claim 28, wherein
the thickness of the second coating is 0.025%˜2.5% of the first thickness.

30. A method as disclosed in claim 28, wherein
step a) comprises degreasing the wire, washing the wire and removing oxide coating from the wire; and
step c) comprises applying the second coating electrolytically by passing the wire 25 with the binding layer through a chamber which comprises or forms an anode made of an oxide-inhibiting metal.

31. A method as disclosed in claim 30, wherein
step a) in addition comprises washing or rinsing the wire after removing the oxide coating; and
step b) comprises, after application of the binding layer, washing the wire with applied binding layer.

32. A method as disclosed in claim 28, wherein
the binding layer consists of zinc (Zn); and
the oxide-inhibiting metal is copper (Cu).

33. Use of welding wire that is produced by the method of claim 28 for welding aluminium or aluminium alloy using alternating current with a frequency selected in the range of 500 Hz-500 kHz and using a shielding gas which contains oxygen.

34. The use of welding wire as disclosed in claim 33, wherein the alternating current is a symmetrical alternating current with no direct current component.

35. The use as disclosed in claim 33, wherein the alternating current is supplied as a constant alternating current or an intermittent or pulsating alternating current.

36. A feedable and consumable welding wire for use for welding aluminium or aluminium alloy, wherein the welding wire is produced according to the method as disclosed in claim 28.

37. A device for producing a welding electrode for use in electric welding of aluminium or aluminium alloy, wherein
the welding electrode is a feedable, consumable welding wire intended for use in welding in a magnetic field;
a plurality of workstations are adapted to treat the welding wire during its passage through the workstations from a store of untreated welding wire of aluminium or aluminium alloy to a store of ready treated welding wire, wherein said plurality of workstations consists of, in sequential order:
a first workstation adapted to degrease and wash the wire;
a second workstation adapted to remove oxide coating from the wire;
a third workstation adapted to apply a binding layer to the wire;
a fourth workstation configured with a wire feedthrough chamber adapted for electrolytic application of an oxide-inhibiting metal coating to the binding layer.

38. A device as disclosed in claim 37, wherein
the exposure time of the wire with applied binding layer in the fourth workstation is so adapted that the oxide-inhibiting coating on passing out of the downstream end of the s fourth workstation has a thickness that is 0.025%-2.5% of the thickness of the welding wire upstream relative to the upstream end of the first workstation.

39. A device as disclosed in claim 37, wherein
the second and the third workstation in addition have a washing section at their respective downstream ends.

40. A device as disclosed in claim 37, wherein
the binding layer consists of zinc (Zn); and
the oxide-inhibiting metal is copper (Cu).

41. A welding gun for gas metal arc welding, so-called GMAW, for use in electric welding of aluminium or aluminium alloy, wherein
the welding gun is constructed for use in welding in a magnetic field, in that all parts within and on the welding gun consist of non-magnetisable material; and
the welding gun is adapted to be supplied with welding current in the form of alternating current selected in the frequency range of 500 Hz-500 kKz, wherein the applied minimum frequency for the alternating current is a function of magnetic field strength.
